(19) United States
(12) Patent Application Publication
(10) Pub. No.: US 2005/0168787 A1
(43) Pub. Date: Aug. 4, 2005

(54) Scanning optical system

(75) Inventor: Takashi Iizuka, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/098,377

(22) Filed: Apr. 5, 2005

Related U.S. Application Data
(62) Division of application No. 10/322,531, filed on Dec. 19, 2002.

(30) Foreign Application Priority Data
Dec. 20, 2001 (JP) 2001-388124

(51) Int. Cl. G02B 26/08

(52) U.S. Cl. 359/205

(57) ABSTRACT

A scanning optical system includes a light source including a multi-mode laser diode that emits a laser beam, and a polygonal mirror that deflects the laser beam emitted by the light source. An fθ lens converges the laser beam deflected by the polygonal mirror on an object to be scanned. The fθ lens includes at least one refractive lens and a diffractive lens structure formed on at least one surface of the at least one refractive lens, the diffractive lens structure being configured to compensate for chromatic aberrations provided by a refractive lens structure of the fθ lens.

This Application is a divisional application of pending U.S. patent application Ser. No. 10/322,531, filed on Dec. 19, 2002, the disclosure of which is expressly incorporated herein by references in its entirety.

### BACKGROUND OF THE INVENTION

The present invention relates to a scanning optical system employed in an optical scanning unit for a laser beam printer or the like.

Typically, a scanning optical system is configured such that a laser beam emitted by a laser diode is deflected by a polygonal mirror to scan within a predetermined angular range. The scanning laser beam is converged by an fθ optical system on an object (which is generally a photoconductive surface) to be scanned, thereby a beam spot being formed on the object to be scanned. The beam spot on the object moves as the polygonal mirror rotates. By ON-OFF modulating the laser beam, an electrostatic latent image is formed on the photoconductive surface. In this specification, a direction where the beam spot moves on the object is referred to as a main scanning direction, and a direction perpendicular to the main scanning direction on the object surface will be referred to as an auxiliary scanning direction. In the following description, a shape and a power of each optical element will be described with reference to the directions on the object. For example, if an element is described to have a refraction power in the main scanning direction, whichever direction the element may be oriented, the power affects the beam spot in the main scanning direction on the object.

The scanning optical system is generally designed such that an optimum performance is achieved at a single design wavelength. A laser diode employed in such a scanning optical system is a single mode laser diode which emits a beam having a single wave length.

The single mode laser diode employed as a laser source of a conventional scanning optical system is more expensive than a multi-mode laser diode, which emits a beam having a plurality of peak wavelengths. Therefore, there has been a desire for making use of the multi-mode laser diode as the laser source so as to reduce a manufacturing cost.

The conventional scanning optical system is, however, designed on assumption of using a single wavelength as described above, and is not configured to compensate for lateral chromatic aberration. Therefore, if the multi-mode laser diode is used for the conventional scanning optical system, a size of the beam spot scanning on the photoconductive drum expands and thus a dot size of an image formed thereon is enlarged, which deteriorates a quality of the formed image.

It is apparent that if the optical system is configured such that the lateral chromatic aberration is compensated, the above problem does not occur even if the multi-mode laser diode is used. However, in order to compensate for the lateral chromatic aberration, a plurality of lenses made of different materials having different dispersions should be used. In such a configuration, even though the cost for the light source is reduced by replacing the single mode laser diode with a multi-mode laser diode, the entire cost of the optical system increases since the cost of the fθ lens increases.

### SUMMARY OF THE INVENTION

The present invention is advantageous in that an improved scanning optical system is provided with which the manufacturing cost of the entire optical system can be reduced with employing the multi-mode laser diode as a light source.

According to an aspect of the invention, there is provided a scanning optical system, which is provided with a light source including a multi-mode laser diode emitting a laser beam, a polygonal mirror that deflects the laser beam emitted by the light source, and an fθ optical element that has positive power both in a main scanning direction and in an auxiliary scanning direction, the fθ optical element converging the laser beam deflected by the polygonal mirror to converge on an object to be scanned. In this scanning optical system, the fθ optical element is configured to have a reflection surface, the power of the fθ optical element in the main scanning direction being provided mainly by the reflection surface.

Since the power in the main scanning direction of the fθ optical element is mainly provided by the reflection surface, the lateral chromatic aberration can be well suppressed. Thus, with this configuration, the multi-mode laser diode can be used as the light source and a sufficient beam size can be achieved without increasing the manufacturing cost of the fθ optical element.

Optionally, the fθ optical element may include an element made of light transmissive material, the element having a first surface that transmits light and a second surface that reflects the light that enters into the element from the first surface.

Still optionally, the polygonal mirror and the fθ optical element are arranged such that the beam incident on the polygonal mirror and the beam deflected by the polygonal mirror forms a certain angle in the auxiliary scanning direction and that the beam incident on the fθ optical element and the beam reflected by the fθ optical element forms a certain angle in the auxiliary scanning direction.

According to another aspect of the invention, there is provided a scanning optical system which is provided with a light source including a multi-mode laser diode emitting a laser beam, a polygonal mirror that deflects the laser beam emitted by the light source, and an fθ lens that converges the laser beam deflected by the polygonal mirror on an object to be scanned. With this structure, the fθ lens is configured to include at least one refractive lens and a diffractive lens structure formed on at least one surface of the at least one refractive lens, the diffractive lens structure being configured to compensate for chromatic aberrations provided by refractive lens structure of the fθ lens.

With the above configuration, the multi-mode laser diode can be used as the light source without increasing the manufacturing cost of the fθ optical system.

Optionally, a central axis of the laser beam incident on the polygonal mirror and an optical axis of the fθ lens are on a same plane and form a predetermined angle.

According to a further aspect of the invention, there is provided a scanning optical system which is provided with a light source including a multi-mode laser diode emitting a laser beam, a polygonal mirror that deflects the laser beam emitted by the light source, and an fθ optically system that converges the laser beam deflected by the polygonal mirror on an object to be scanned, the fθ lens being configured to suppress lateral chromatic aberration. In particular, the lateral chromatic aberration is suppressed by employing at least one of (a) a reflection surface having a predetermined power in the main scanning direction and (b) a diffractive lens structure that compensates for chromatic aberrations provided by a refractive lens structure of the fθ lens.

### BRIEF DESCRIPTION OF THE ACCOMPANYING DRAWINGS

FIG. 1 a perspective view of a scanning optical system according to a first embodiment of the invention;

FIG. 2 is a view, taken along a plane perpendicular to an auxiliary scanning direction, of the scanning optical system according to the first embodiment;

FIG. 3 is a view, taken along a plane perpendicular to a main scanning direction, of the scanning optical system according to the first embodiment;

FIGS. 4A-4C are graphs indicating an fθ error, curvature of field and lateral chromatic aberration of the scanning optical system according to the first embodiment;

FIG. 5 is a view, taken along a plane perpendicular to an auxiliary scanning direction, of a scanning optical system according to a second embodiment;

FIGS. 6A and 6B are side and front view of a first lens of an fθ lens employed in the scanning optical system according to the second embodiment; and

FIGS. 7A-7C are graphs indicating an fθ error, curvature of field and lateral chromatic aberration of the scanning optical system according to the second embodiment.

### DETAILED DESCRIPTION OF THE EMBODIMENTS

Hereinafter, scanning optical systems according to two embodiments of the invention will be described with reference to accompanying drawings.

According to the embodiments, the scanning optical systems are to be employed in an exposure unit of a laser beam printer. The exposure unit emits a scanning laser beam which is ON-OFF modulated in accordance with an input image signal to the photoconductive drum to form an electrostatic latent image thereon.

First Embodiment

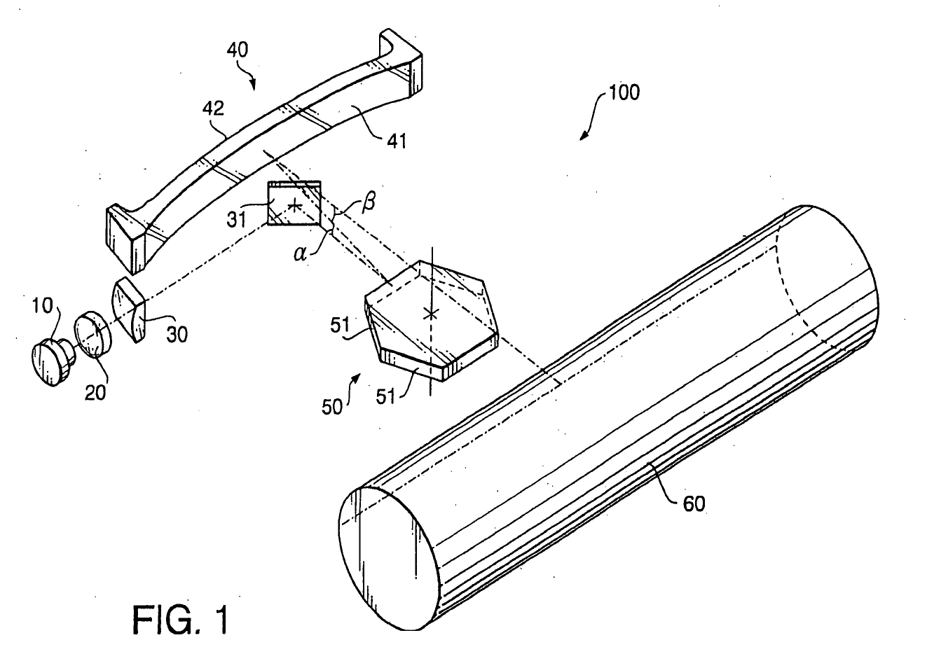

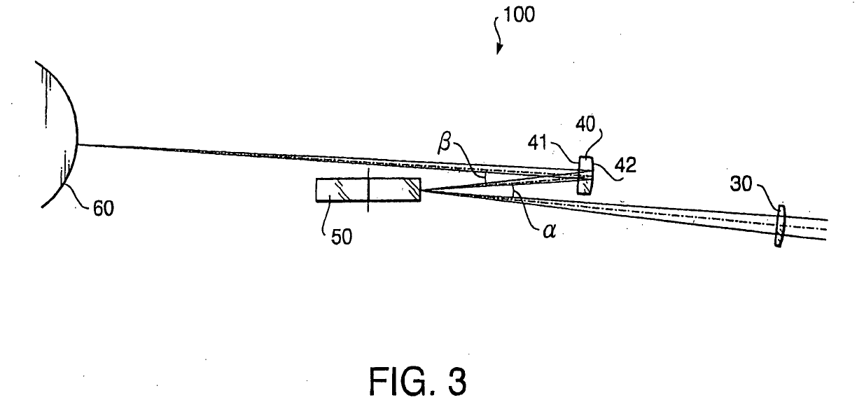

FIG. 1 a perspective view of a scanning optical system 100 according to a first embodiment of the invention. The scanning optical system 100 employs a multi-mode laser diode 10. The laser diode 10 emits a diverging laser beam, which is collimated by a collimating lens 20. The collimated laser beam is incident on an anamorphic lens 30, which has a relatively strong positive power in the auxiliary scanning direction and a relatively week negative power in the main scanning direction. The laser beam passed through the anamorphic lens 30 is reflected by a planar mirror 31 and incident on the polygonal mirror 50 with a certain angle in the auxiliary scanning direction (see FIG. 3).

The beam incident on the polygonal mirror 50 is reflected by reflection surfaces 51 thereof with a first separation angel a in the auxiliary scanning direction. The reflected laser beam is incident on the fθ optical element 40. The fθ optical element 40 is formed of transparent material having a first surface 41 which allows the beam to pass therethrough, and a second surface 42 which reflects the beam incident from the first surface 41 on its inner surface. The beam reflected by the inner surface of the second surface 42 passes through the first surface 41 again, and exits therefrom.

The second surface 42 is formed with a reflection coating of silver or aluminum by deposition so that the beam is reflected on its inner surface. The first surface 41 and the second surface 42 incline macroscopically with respect each other in the auxiliary scanning direction.

The laser beam exiting from the fθ optical element 40 proceeds toward the polygonal mirror 50 with a second separation angle β in the auxiliary scanning direction between the incident beam and the exiting beam. The beam passes above the polygonal mirror in FIG. 1, and forms a beam spot, which scans in the main scanning direction that is parallel with a generatrix of a cylindrical shape of the photoconductive drum 60.

It should be noted that the positive power of the fθ optical element 40 in the main scanning direction is mainly provided by the second surface 42 which is the reflection surface. Accordingly, the lateral chromatic aberration is well suppressed, and the beam emitted by the multi-mode laser diode 10 can be sufficiently converged to form a beam spot having a sufficiently small size.

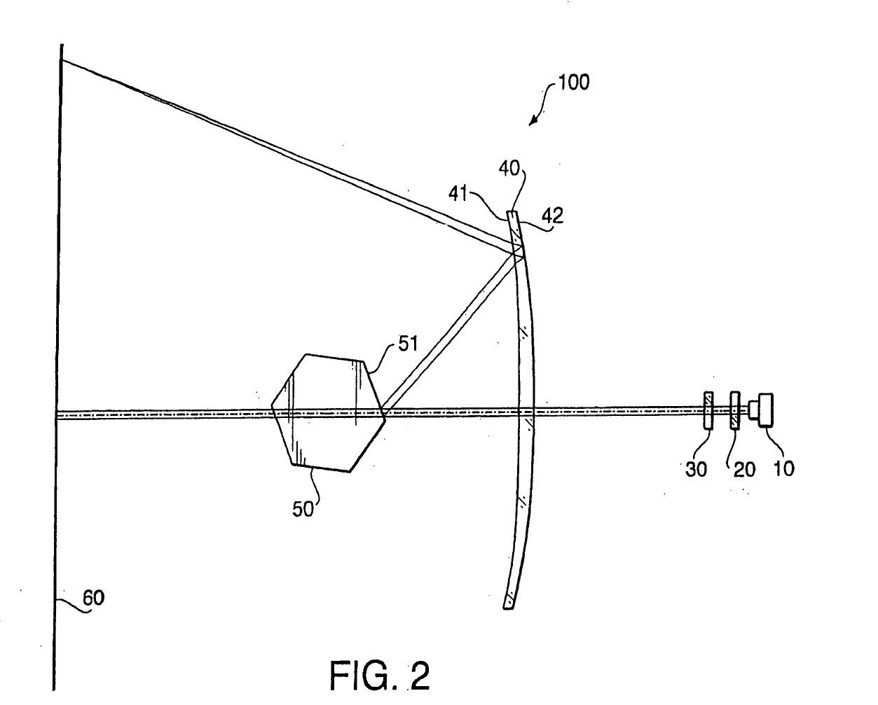

FIG. 2 is a view, taken along a plane perpendicular to an auxiliary scanning direction, of the scanning optical system according to the first embodiment. FIG. 3 is a view, taken along a plane perpendicular to a main scanning direction, of the scanning optical system according to the first embodiment.

In each of FIGS. 2 and 3, a structure of the scanning optical system from the anamorphic lens 30 to the photoconductive drum 60 is shown. In FIG. 2, the laser diode 10 and the collimating lens 20 are also shown. It should be noted that, in FIG. 2 or 3, a mirror 31 is omitted from the drawing, and an optical path between the anamorphic lens 30 and the polygonal mirror 50 is indicated as a developed path.

TABLE 1 indicates a concrete example of the scanning optical system according to the first embodiment of the invention. In the table, α denotes the first separation angle, β denotes the second separation angle, ry denotes radius of curvature of each surface in the main scanning direction, rz denotes radius of curvature of each surface in the auxiliary scanning direction (indication thereof will be omitted where the surface is a rotationally symmetrical one), d denotes a distance between adjoining surfaces on the optical axis, and n denotes a refractive index at a wavelength of 780 nm.

Surface numbers indicated in the table are assigned to the surfaces of the optical elements in the order where the laser beam proceeds. That is, surfaces #1 and #2 represent surfaces of the anamorphic lens 30, surface #3 represents the mirror surfaces 51 of the polygonal mirror 50, surface #4 represents the first surface 41 of the fθ optical system 40, surface #5 represents the second surface 42 of the fθ optical system 40, and surface #6 represents the first surface 41 of the fθ optical system 40 (i.e., surfaces #4 and #6 indicate the same surface).

TABLE 1
scanning coefficient: 135.5 α = 10.0° β = 8.0°

| Surface | ry | rz | d | n |
|---|---|---|---|---|
| #1 | −72.000 | 55.424 | 2.000 | 1.48617 |
| #2 | ∞ | — | 113.000 | |
| #3 | ∞ | — | 50.000 | |
| #4 | −265.075 | ∞ | 5.000 | 1.48617 |
| #5 | −231.860 | TABLE 3 | 5.000 | 1.48617 |
| #6 | −265.075 | ∞ | 160.035 | |

The first surface 41 (i.e., surfaces #4 and #6) is an anamorphic aspherical surface which is not a rotationally symmetrical surface. The shape of the first surface 41 along the main scanning direction is expressed by a SAG X(Y) which is a function of a coordinate Y in the main scanning direction.

$$X ( Y ) = \frac{{Y}^{2}}{r ( 1 + \sqrt{1 - \frac{( κ + 1 ) {Y}^{2}}{{r}^{2}}} )} + \sum {AMpY}^{p} \qquad ( 1 )$$

where, it is assumed that the shape in the main scanning direction passes a predetermined origin, and Y is a coordinate, with respect to the origin, of a point on the first surface 41 along the main scanning direction, X(Y) is a SAG amount which represents a distance of the point on the first surface 41 with respect to a plane tangential to the first surface 41 at the origin, r represent a radius of curvature at the origin, κ represents a conical coefficient and AMp is a p-th order aspherical coefficient (p being an integer).

The shape of the first surface 41 in the auxiliary scanning direction is an arc, whose curvature Cz(Y) at a coordinate Y in the main scanning direction is expressed by equation (2):
Cz(Y)=Czo+ΣASqY^{q} (2)
where, Czo is a curvature in the auxiliary scanning direction on the origin, and ASq represents a q-th order curvature coefficient.

The values of the coefficients AMp and ASq for equations (1) and (2) are indicated in TABLE 2.

It should be noted that the radius of curvature in the auxiliary scanning direction at the origin of the first surface 41 is infinity, and therefore, the curvature Czo is zero. Further, since the values for odd order of AMp and ASq are zero, TABLE 2 indicates the values for even order thereof. As understood from the equations, the first surface 41 is symmetrical in the main scanning direction with respect to the origin, and also symmetrical in the auxiliary scanning direction with respect to the origin since the shape in the auxiliary scanning direction is an arc.

TABLE 2

| | |
|---|---|
| MAIN SCANNING | AUXILIARY SCANNING |
| DIRECTION | DIRECTION |

| | | | |
|---|---|---|---|
| κ | 0.0 | — | |
| AM2 | 9.57071 × 10⁻⁰⁴ | AS2 | 3.32077 × 10⁻⁰⁸ |
| AM4 | −6.81320 × 10⁻¹¹ | AS4 | −1.02051 × 10⁻¹¹ |
| AM6 | −3.84519 × 10⁻¹¹ | AS6 | −5.96555 × 10⁻¹⁵ |
| AM8 | −9.94042 × 10⁻¹⁸ | AS8 | 1.46273 × 10⁻¹⁶ |
| AM10 | −5.33698 × 10⁻²¹ | AS10 | 0.0 |
| AM12 | −1.13355 × 10⁻²⁴ | AS12 | 0.0 |

The second surface 42 (surface #5) of the fθ optical element 40 is expressed by a SAG X(Y, Z) which is a function of Y and Z coordinates, where Y is a height of a point on the second surface 42 in the main scanning direction with respect to an origin and Z is a height of the point in the auxiliary scanning direction.

$$X ( Y , Z ) = \frac{{Y}^{2} + {Z}^{2}}{r ( 1 + \sqrt{1 - \frac{( κ + 1 ) ( {Y}^{2} + {Z}^{2} )}{{r}^{2}}} )} + \sum {B}_{mn} {Y}^{m} {Z}^{n} \qquad ( 3 )$$

where, the SAG X(Y,Z) represents a distance of the point on the second surface 42 with respect to an imaginary reference plane, r is a radius of curvature of the surface at the origin, κ is a conical coefficient and Bmn is a coefficient.

Each of the reference plane referred to for defining the second surface 42 and the tangential plane referred to when defining the first surface 41 is perpendicular to a predetermined reference axis, and intersection point of the reference axis and each of the first and second surfaces 41 and 42 is defined as the origin for each surface.

The values of the coefficients Bmn are indicated in TABLE 3. It should be noted that, in the auxiliary scanning direction, coefficients Bmn for terms having only a first-order component (i.e., odd-order terms) have values other than zero. Therefore, the second surface 42 is inclined, in the auxiliary scanning direction, with respect to the reference plane. In the main scanning direction, the coefficients Bmn for odd-order terms are zero, and therefore, the second surface 42 is symmetrical, in the main scanning direction, with respect to the origin.

TABLE 3 includes values for odd numbers of n, but does not include values for odd number of m since they are zero.

TABLE 3

| Bmn | n = 0 | n = 1 | n = 2 | n = 3 | n = 4 |
|---|---|---|---|---|---|
| m = 0 | 0.0 | −4.7676 × 10⁻⁰² | −1.9823 × 10⁻⁰³ | −2.6829 × 10⁻⁰⁶ | 1.6459 × 10⁻⁰⁶ |
| m = 2 | 2.9399 × 10⁻⁰⁴ | 3.0589 × 10⁻⁰⁶ | 2.0803 × 10⁻⁰⁷ | −1.8380 × 10⁻⁰⁹ | −3.9318 × 10⁻¹² |
| m = 4 | 3.9253 × 10⁻⁰⁸ | 4.4950 × 10⁻¹⁰ | −2.8244 × 10⁻¹¹ | 4.6055 × 10⁻¹³ | −1.6421 × 10⁻¹³ |
| m = 6 | −1.6234 × 10⁻¹¹ | −5.9046 × 10⁻¹⁰ | 2.1719 × 10⁻¹⁴ | −8.1058 × 10⁻¹⁶ | −4.4493 × 10⁻¹⁷ |
| m = 8 | 1.0587 × 10⁻¹⁵ | 2.1083 × 10⁻¹¹ | 9.7026 × 10⁻¹⁸ | 4.8969 × 10⁻¹⁹ | 1.6297 × 10⁻²⁰ |
| m = 10 | −5.8655 × 10⁻¹⁹ | −3.1655 × 10⁻²⁰ | 3.4090 × 10⁻²¹ | 0.0 | 0.0 |
| m = 12 | 8.2703 × 10⁻²³ | 0.0 | 0.0 | 0.0 | 0.0 |

The tangential plane to the first surface 41 and the reference plane for the second surface 42 are parallel to each other, and are perpendicular to the same reference axis. The first surface 41 does not incline with respect to the tangential plane, while the second surface 42 inclines, in the auxiliary scanning direction, with respect to the reference plane. Therefore, macroscopically, the first surface 41 and the second surface 42 are inclined with respect to each other in the auxiliary scanning direction.

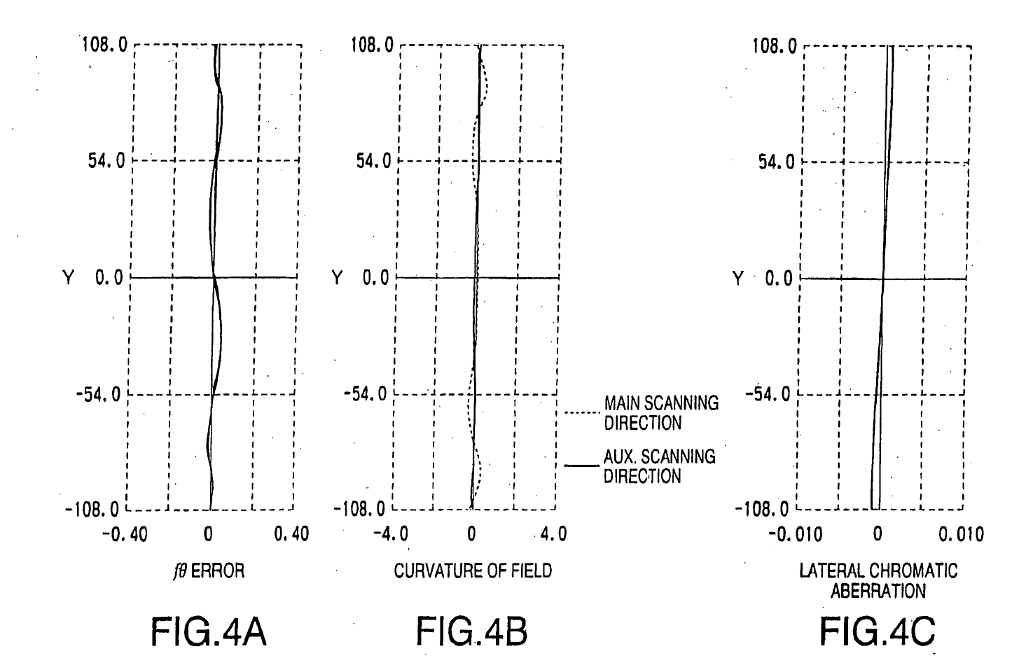

FIGS. 4A-4C are graphs indicating an fθ error, curvature of field (broken line: main scanning direction; solid line: auxiliary scanning direction) and lateral chromatic aberration (wavelength difference: 2 nm) of the scanning optical system 100 according to the first embodiment. In each graph, the vertical axis represents an image height (i.e., a distance in the main scanning direction with respect to the center of a scanning range on the photoconductive drum), and the horizontal axis represents the quantity of aberration (unit: mm). Since the power in the main scanning direction is achieved mainly by the reflection surface, the lateral chromatic aberration is well suppressed.

Second Embodiment

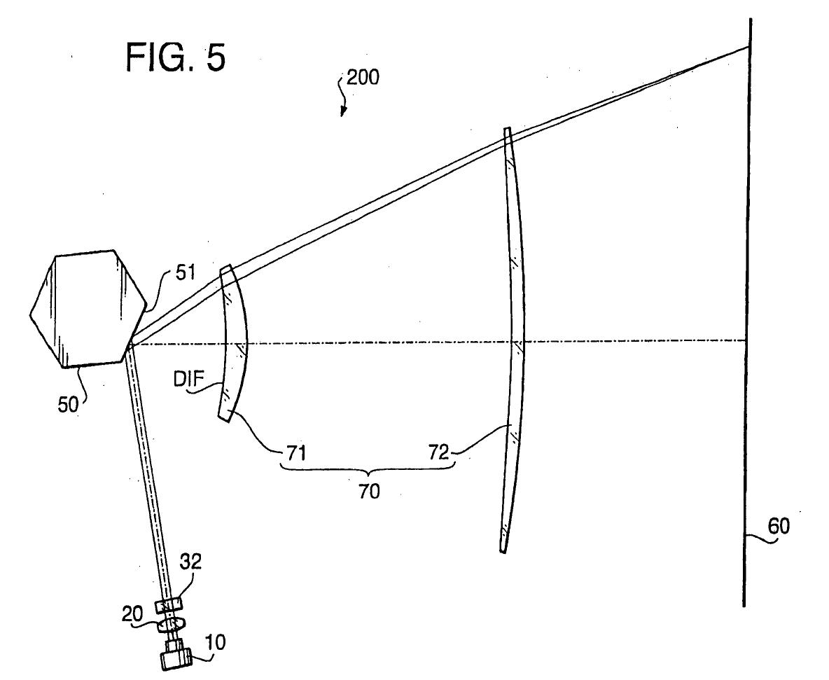

FIG. 5 is a view, taken along a plane perpendicular to an auxiliary scanning direction, of a scanning optical system 200 according to a second embodiment.

Similarly to the first embodiment, the scanning optical system 200 employs the multi-mode laser diode 10 and the collimating lens 20. The laser beam collimated by the collimating lens 20 is incident on a cylindrical lens 32 which has a positive power only in the auxiliary scanning direction. The laser beam passed through the cylindrical lens 32 is deflected by the polygonal mirror 50 and incident on an fθ lens 70, which converges the laser beam on the photoconductive drum 60 to form a beam spot thereon. According to the second embodiment, the central axis of a beam incident on the polygonal mirror 50 and the optical axis of the fθ lens are on the same plane and form a predetermined angle. With this configuration, the amount of bow generated by the fθ lens can be reduced. In contrast to the second embodiment, according to the structure of the first embodiment, the size of the scanning optical system can be made smaller.

The fθ lens 70 includes a first lens 71 located on the polygonal mirror side and a second lens 72 located on the photoconductive drum side. Further, a polygonal mirror side surface of the first lens 71 is formed with a transmissive diffraction surface DIF.

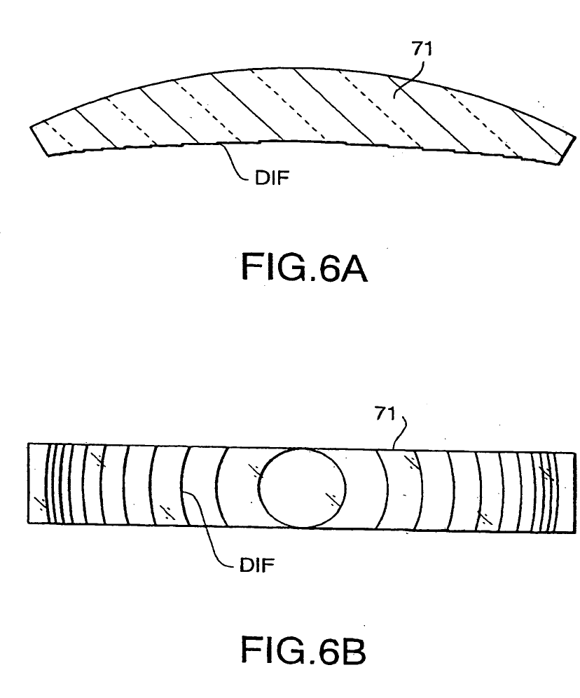

FIG. 6A is a side view of the first lens 71, and FIG. 6B is a front view, viewed from the polygonal mirror side, of the first lens 71.

As shown in FIG. 6A, the diffraction lens structure DIF has steps whose pitch is smaller at an outer portion thereof. The boundaries of the steps are, when viewed from the polygonal mirror side, formed to be a part of concentric circles as shown in FIG. 6B.

It should be noted that FIGS. 6A and 6B show exaggerated view, where the number of steps are less than the actual number, and the height of steps are larger than the actual height for the sake of brevity.

The fθ lens 70 has a simple structure consisting of only two refractive lenses. However, by forming the diffractive lens structure DIF, the lateral chromatic aberration is well compensated, the laser beam emitted by the multi-mode laser diode can be converged to a necessary size. An example of the diffractive lens structure employed in a scanning optically system and compensates for the lateral chromatic aberration is disclosed in U.S. Pat. No. 6,259,547, the teachings of which are incorporated herein by reference.

TABLE 4 indicates the numerical structure of the scanning optical system 200. In the TABLE 2, surfaces #1 and #2 represent the cylindrical lens 32, surface #3 represents the reflection surface 51 of the polygonal mirror 50, surfaces #4 and #5 represent the fist lens 71 and surfaces #6 and #7 represent the second lens 72 of the fθ lens 70. The focal length of the diffraction lens surface DIF is 5089.159 mm.

TABLE 4
scanning coefficient: 200.000

| Surface | ry | rz | d | n |
|---|---|---|---|---|
| #1 | ∞ | 55.424 | 2.00 | 1.48617 |
| #2 | ∞ | — | 97.00 | |
| #3 | ∞ | — | 40.00 | |
| #4 | −153.034 | — | 8.50 | 1.48617 |
| #5 | −61.827 | — | 110.00 | |
| #6 | −497.023 | 31.077 | 5.00 | 1.48617 |
| #7 | −497.950 | — | 90.00 | |

The polygonal mirror side surface (#4) of the first lens 71 is configured such that the diffraction lens structure DIF is formed on a spherical base curve. The other surface (#5) of the first lens 71 is a rotationally symmetrical aspherical surface.

The rotationally symmetrical aspherical surface is expressed by a SAG X(h) which represents a distance from a plane tangential to the rotationally symmetrical aspherical surface at the optical axis thereof to a point thereon, whose height with respect to the optical axis is h. The SAG X(h) is expressed by the following equation.

$$X ( h ) = \frac{{h}^{2}}{r ( 1 + \sqrt{1 - \frac{( κ + 1 ) {h}^{2}}{{r}^{2}}} )} + \sum {A}_{p} {h}^{p} \qquad ( 4 )$$

where, κ is a conical coefficient, r is a radius of curvature of the aspherical surface at the optical axis, and Ap is an aspherical coefficient for p-th order term.

The values of κ and Ap are indicated in TABLE 5.

TABLE 5

| | |
|---|---|
| κ | 0.00000 |
| A4 | 2.07880 × 10⁻⁰⁷ |
| A6 | −2.92095 × 10⁻¹¹ |
| A8 | 2.10239 × 10⁻¹⁴ |

The polygonal mirror side surface (#6) of the second lens 72 is an anamorphic aspherical surface, which is similar to the first surface (#4 and #6) of the fθ optical element 41 of the first embodiment, and is expressed by the equations (1) and (2). The values of the coefficients defining the surface #6 are indicated in TABLE 6.

TABLE 6

| | |
|---|---|
| MAIN SCANNING | AUXILIARY SCANNING |
| DIRECTION | DIRECTION |

| | | | |
|---|---|---|---|
| κ | 0.0 | — | |
| AM2 | 0.0 | AS2 | −2.56679 × 10⁻⁰⁶ |
| AM4 | 1.07453 × 10⁻⁰⁷ | AS4 | −8.41951 × 10⁻⁰⁷ |
| AM6 | −5.45956 × 10⁻¹² | AS6 | 5.51026 × 10⁻¹² |
| AM8 | 2.14629 × 10⁻¹⁶ | AS8 | 6.98197 × 10⁻¹⁶ |

The surface #7 of the second lens 72 is a spherical surface.

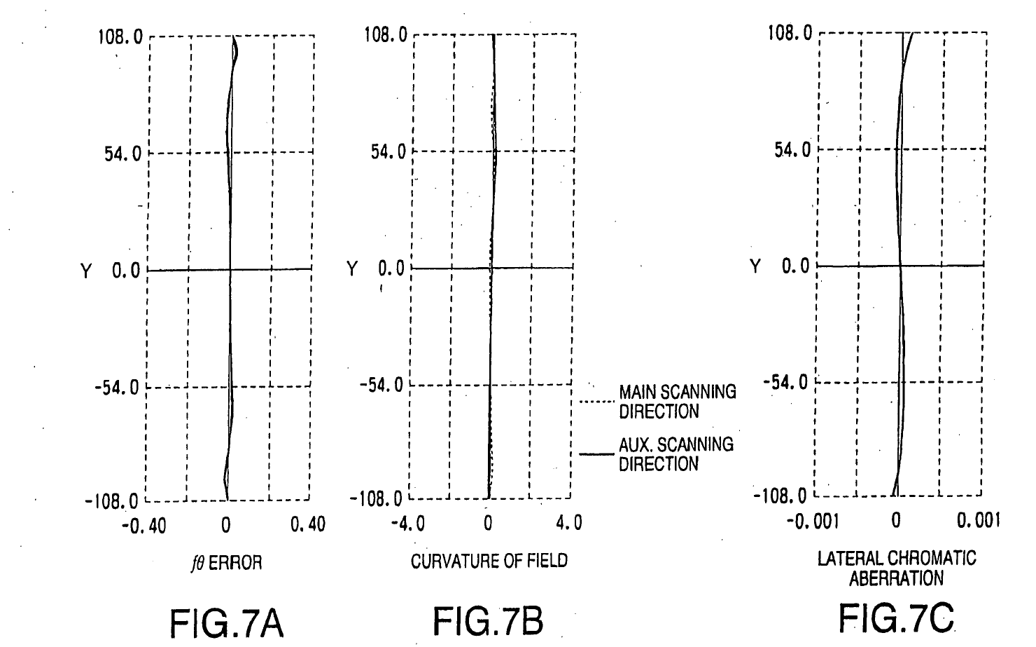

FIGS. 7A-7C are graphs indicating an fθ error, curvature of field (broken line: main scanning direction; solid line: auxiliary scanning direction) and lateral chromatic aberration (wavelength difference: 2 nm) of the scanning optical system 200 according to the second embodiment. In each graph, the vertical axis represents an image height (i.e., a distance in the main scanning direction with respect to the center of a scanning range on the photoconductive drum), and the horizontal axis represents the quantity of aberration (unit: mm). With use of the diffraction lens structure DIF, the lateral chromatic aberration is well suppressed.

The present disclosure relates to the subject matter contained in Japanese Patent Application No. 2001-388124, filed on Dec. 20, 2001, which is expressly incorporated herein by reference in its entirety.

1. A scanning optical system, comprising:
a light source including a multi-mode laser diode emitting a laser beam;
a polygonal mirror that deflects the laser beam emitted by said light source; and
an fθ lens that converges the laser beam deflected by said polygonal mirror on an object to be scanned,
wherein said fθ lens includes at least one refractive lens and a diffractive lens structure formed on at least one surface of said at least one refractive lens, said diffractive lens structure being configured to compensate for chromatic aberrations provided by a refractive lens structure of said fθ lens.

2. The scanning optical system according to claim 1, wherein a central axis of the laser beam incident on the polygonal mirror and an optical axis of said fθ lens are on a same plane and form a predetermined angle.

3. A scanning optical system comprising:
a light source including a multi-mode laser diode emitting a laser beam;
a polygonal mirror that deflects the laser beam emitted by said light source; and
an fθ optical system that converges the laser beam deflected by said polygonal mirror onto an object to be scanned, said fθ lens being configured to suppress lateral chromatic aberration,
wherein the lateral chromatic aberration is suppressed by employing at least one of a reflection surface having a predetermined power in the main scanning direction or a diffractive lens structure that compensates for chromatic aberrations provided by a refractive lens structure of said fθ lens.
